(19) United States
(12) Patent Application Publication
(10) Pub. No.: US 2008/0281463 A1
(43) Pub. Date: Nov. 13, 2008

(54) Method of Non-Linear Process Planning and Internet-Based Step-Nc System Using the Same

(76) Inventors: Suk hwan Suh, Pohang-si (KR); Dae hyuk Chung, Pohang-si (KR); Byeong eon Lee, Pohang-si (KR)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 12/161,319

(22) PCT Filed: Jan. 31, 2006
(86) PCT No.: PCT/KR2006/000330

§ 371 Date: Jul. 17, 2008

(30) Foreign Application Priority Data
Jan. 18, 2006 (KR) 10-2006-0005570

(51) Int. Cl. G06F 19/00

(52) U.S. Cl. 700/182

(57) ABSTRACT

The present invention relates to a method of creating a non-linear process plan and an Internet-based STEP-NC system using the same, and more particularly, to a method of creating a non-linear process plan, wherein the non-linear process plan including information on a variety of alternative processes and machining sequences is established in consideration of situations in the field, thereby autonomously dealing with abnormal situations while executing optimal machining, and to an Internet-based STEP-NC system, wherein a STEP-NC part program in an XML format is created based on the established process plan so that process information can be easily exchanged with other systems via the Internet. Since the present invention provide a plurality of machining alternatives to the field, and thus, allow a STEP-NC machine tool to execute machining optimized depending on field situations and to autonomously deal with abnormal situations that may occur during machining.

### TECHNICAL FIELD

The present invention relates to a method of creating a non-linear process plan and an Internet-based STEP-NC system using the same, and more particularly, to a method of creating a non-linear process plan, wherein the non-linear process plan including information on a variety of alternative processes and machining sequences is established in consideration of situations in the field, thereby autonomously dealing with abnormal situations while executing optimal machining, and to an Internet-based STEP-NC system, wherein a STEP-NC part program in an XML format is created based on the established process plan so that process information can be easily exchanged with other systems via the Internet.

### BACKGROUND ART

Since a three-axis numerically controlled milling machine was developed in the MIT in 1952, numerical control (NC) machining techniques have been remarkably developed and evolved into computer numerical control (CNC) machining techniques along with advancements in electronic engineering technologies including microprocessor technologies.

A CNC machining method that is most generally used in the field is a method of creating a part program from shape design information including drawings of a product through computer-aided design/computer-aided manufacturing (CAD/CAM) software and inputting the part program into a machine tool mounted with a CNC controller (hereinafter, referred to as a CNC machine tool), thereby performing machining.

A general part program describes a process plan, which has been previously established according to a machining sequence, in a G-code format, so that sequential machining can be performed according to a process sequence described in the G-code.

For example, if tens of holes are intended to be machined, a detailed sequence of holes to be machined should be specified in the step of planning a process to program the process in the G-code. Thus, there is a problem in that if the process needs to be optimized to a particular situation before machining, or an abnormal situation happens due to breakage of a drill or the like while machining, the machining sequence is not easy to change. That is, since the NC controller that receives the part program of G-codes has only information on axial motions in a fixed sequence, it is difficult to appropriately change the machining sequence or conditions in an abnormal situation such as breakage of a tool or the like, and, the process plan or part program is not easy to immediately change on the field if preplanned tools or fixtures are not provided at the time of machining.

A STEP-NC language based on STEP (STandard for the Exchange of Product model data) data model is spotlighted as a new programming language to solve the problem. A part program prepared in the STEP-NC language defines process plan information capable of creating axial motions, such as shape information, machining sequences, machining methods and tool information, instead of defining the axial motions, and thus, it has an advantage in that machining sequences or conditions can be easily changed.

However, since the STEP-NC part program is created with hardware neutral information for versatility, the STEP-NC part program cannot satisfy structures of all kinds of currently existing CNC machine tools. Accordingly, STEP-NC machining information needs to be appropriately changed so as to meet the structure of a machine tool after the STEP-NC part program is inputted, and there is a need for a method of creating and processing new alternative machining in addition to existing STEP-NC machining information, in the process of changing the STEP-NC machining information.

Meanwhile, with advancements in information technology (IT), studies on e-manufacturing environments are being conducted, in which business supporting systems such as enterprise resource planning (ERP), customer relation management (CRM) and supply chain management (SCM), and field production systems such as a manufacturing execution system (MES) and product data management (PDM) are connected through the Internet so that the respective systems can share information.

Accordingly, there is a need for development of intelligent NC controllers that can freely exchange machining information with other systems using the Internet and can autonomously deal with situations in the field.

### DISCLOSURE OF INVENTION

### Technical Problem

The present invention is conceived to solve the aforementioned problems and to meet requirements. Accordingly, an object of the present invention is to provide a method of creating a non-linear process plan, wherein non-linear process plan information including information on a variety of alternative processes and machining sequences obtained in consideration of situations in the field is created based on a STEP-NC data model, thereby autonomously dealing with abnormal situations while executing optimal machining.

Another object of the present invention is to provide an Internet-based STEP-NC system, which creates process information that can be easily exchanged with other systems through the Internet, thereby facilitating exchange, management, and storage of the process information in an e-manufacturing environment.

### Technical Solution

The present invention having a technical spirit for achieving the objects provides an Internet-based STEP-NC system for controlling a STEP-NC machine tool by using a non-linear process plan, comprising an interface unit for receiving CAD information, machine information and tool information, and for processing input and output of a STEP-NC part program in an XML format; an NPS (Neutral Process Sequence) creating unit for creating NPS information from CAD data transmitted from the interface unit; an EPS (Executive Process Sequence) creating unit for creating HPS (Hardware-dependent Process Sequence) information, EPS information, and tool paths from machine tool configuration information and tool information transmitted from the interface unit and the NPS information created by the NPS creating unit; and an autonomous control unit for controlling the machine tool, machining a workpiece, and dealing with abnormal situations based on the EPS information transmitted from the EPS creating unit.

### ADVANTAGEOUS EFFECTS

Since the method of creating a non-linear process plan according to the present invention provides a plurality of machining alternatives in the field, so that a STEP-NC machine tool can execute machining optimized for field situations and autonomously deal with abnormal situations that may occur while machining, there are advantages in that it is possible to prevent decrease in productivity due to machining delay or the like and to easily construct an unmanned machining system.

Further, since an executive process sequence optimized for a multi-tasking machine is provided, there is an advantage in that multi-tasking efficiency can be greatly improved.

Furthermore, since the Internet-based STEP-NC system according to the present invention allows efficient transfer of information without loss in an environment in which the system is connected to external systems, such as CAD, CAM, MES and PDM, and also allows machining and tool information in the field to be utilized in a variety of systems, there is an advantage in that the system can contribute to enhancement of productivity.

In addition, since machine tools provided with the Internet-based STEP-NC system according to the present invention can freely exchange STEP-NC part programs in an XML format with one another through the Internet, there are advantages in that global manufacturing can be made independently of the type of machine tool, and machining preparation time can be reduced by sharing a variety of STEP-NC part programs.

### BRIEF DESCRIPTION OF THE DRAWINGS

FIG. 1 is a view showing the configuration of an Internet-based STEP-NC system according to an embodiment of the present invention.

FIG. 2 is a view showing an example of a STEP-NC part program in an XML format, which is inputted and outputted through a STEP-NC interface unit shown in FIG. 1.

FIG. 3 is a view showing a final shape of a machined material to which a method of planning a non-linear process according to an embodiment of the present invention is applied.

FIGS. 4 and 5 are views showing examples of volume removal for machining a workpiece into the shape shown in FIG. 3.

FIG. 6 is a flowchart illustrating a method of creating a non-linear process plan using the Internet-based STEP-NC system according to an embodiment of the present invention.

FIG. 7 is a detailed flowchart illustrating the step of establishing an NPS shown in FIG. 6.

FIG. 8 is a view showing an NPSG for the NPS information created in the procedure of FIG. 7.

FIG. 9 is a detailed flowchart illustrating the step of establishing an HPS shown in FIG. 6.

FIG. 10 is a view showing an HPSG for the HPS information created in the procedure of FIG. 9.

FIG. 11 is a view showing the steps of executing one cycle in parallel machining by a multi-tasking machine.

FIG. 12 is a detailed flowchart illustrating the step of establishing an EPS shown in FIG. 6.

FIG. 13 is a view showing an ETAWS created from the HPSG shown in FIG. 10.

FIG. 14 is a view showing an EPSG for the EPS information created in the procedure of FIG. 12.

FIG. 15 is a view showing a CTEM.

FIG. 16 is a detailed flowchart illustrating the step of calculating an optimal solution shown in FIG. 12.

FIG. 17 is a view showing an example of a solution search tree for obtaining a local solution shown in FIG. 16.

### EXPLANATION OF REFERENCE NUMERALS FOR MAIN PORTIONS IN DRAWINGS

100: NPS creating unit
200: EPS creating unit
300: Autonomous control unit
310: Machining execution section
320: Abnormal situation dealing section
330: On-machine measuring and analyzing section
340: Re-machining section
400: Interface unit
410: Standard CAD interface
420: STEP-NC part program interface
430: Machine tool configuration information interface
440: Tool information interface
450: G-code interface

### BEST MODE FOR CARRYING OUT THE INVENTION

Hereinafter, preferred embodiments of the present invention will be described in detail with reference to the accompanying drawings.

An Internet-based STEP-NC system according to an embodiment of the present invention creates non-linear process plan information categorized into NPS (Neutral Process Sequence) information, HPS (Hardware-dependent Process Sequence) information, and EPS (Executive Process Sequence) information on the basis of a STEP-NC data model, and then performs machining according to the non-linear process plan information.

The NPS information is process plan information independent of a machine tool, and includes information on all executable workingsteps in a state where an execution sequence is not considered and information on alternative workingsteps that can be selectively executed. The NPS information can be expressed as a STEP-NC part program conforming to the ISO 14649 data model specification.

The HPS information is process plan information in a hardware-dependent intermediate step for performing machining in hardware, such as a specific machine tool, using hardware neutral NPS information. The HPS information includes hardware-related information as additional information. The hardware-related information includes hardware resources, machining methods and the like for executing a corresponding workingstep for respective workingsteps contained in the NPS information by using information on the configuration of machine tools and information on tools in the field.

The EPS information is finally created after creating the NPS and HPS information and is sequential process plan information that allows the entire workingsteps of the HPS information to be optimally executed so that the EPS information can be used for machining by a machine tool.

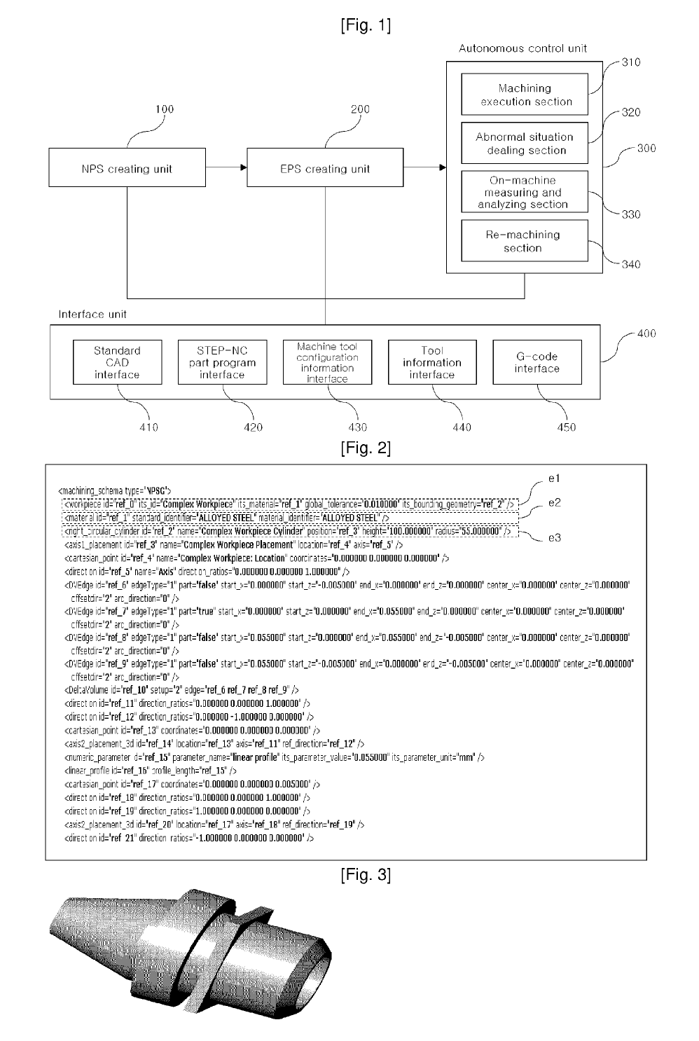

FIG. 1 is a view showing the configuration of an Internet-based STEP-NC system according to an embodiment of the present invention.

As shown in FIG. 1, the Internet-based STEP-NC system according to the embodiment of the present invention includes an interface unit 400 for processing input and output information; an NPS creating unit 100 for creating NPS information from CAD data, i.e., shape design information of a workpiece; an EPS creating unit 200 for creating EPS information and tool paths suitable for the structure of a machine tool using the NPS information; and an autonomous control unit 300 for performing machining of the workpiece by controlling the machine tool based on the created EPS information.

The interface unit 400 comprises a standard CAD interface 410, a STEP-NC part program interface 420, a machine tool configuration information interface 430, a tool information interface 440, and a G-code interface 450.

The standard CAD interface 410 functions to receive CAD information expressed in ISO 10303 AP 203 or AP224 and to analyze the CAD information. The STEP-NC part program interface 420 analyzes an inputted STEP-NC (ISO 14649) part program to convert it into machining information, and converts machining information into a STEP-NC (ISO 14649) part program to output the converted part program. Here, the STEP-NC part program interface 420 is preferably configured to input and output a STEP-NC part program formed in a physical file format based on ISO 10303 Part 21 as well as in an XML format so as to freely exchange the STEP-NC part program created in a language neutral to a machine tool and a controller through the Internet. The STEP-NC part program in an XML format will be described later.

In addition, the machine tool configuration information interface 430 and the tool information interface 440 receive machine tool configuration information or tool information and convert the received information into internal information, or convert internal information into machine tool configuration information or tool information to be outputted. Here, the tool information interface 440 can analyze tool information that is based on the international tool standards of ISO 13399 and ISO 1832 and the international tool holder standards of ISO 5602. Finally, the G-code interface 450 converts cutting location (CL) tool path information created by the autonomous control unit 300 into G-codes.

The NPS creating unit 100 creates a removal volume of a material to be machined from CAD information received through the standard CAD interface 410, recognizes a feature shape corresponding to the removal volume, receives tolerance information from a user, and creates NPS information by referring to the recognized feature shape and the tolerance information. Here, the created NPS information can be converted into a STEP-NC part program in an XML format through the STEP-NC part program interface 420 and then provided to an external system.

The EPS creating unit 200 receives the NPS information, machine tool configuration information, and field tool information and creates HPS information having additional information on hardware resources (spindles, turrets, and tools) that can be used for machining in each workingstep and on a possibility of simultaneous machining (one-feature simultaneous machining or two-feature simultaneous machining). Then, the EPS creating unit creates EPS information from the created HPS information by determining an execution sequence of workingsteps to minimize a machining time, determining whether simultaneous machining is applied, and determining workingsteps to be executed among alternative workingsteps.

Here, the method of creating each non-linear process plan (NPS, HPS, and EPS) information by the NPS creating unit 100 and the EPS creating unit 200 will be described in detail below.

The autonomous control unit 300 includes a machining execution section 310 for executing a machining process according to the HPS and the EPS information created by the EPS creating unit 200; an abnormal situation dealing section 320 for searching for an alternative tool or an alternative workingstep in an abnormal situation and recreating a tool path; an on-machine measuring and analyzing section 330 for measuring a tolerance and a machining error for a part while executing machining or after machining, analyzing measurement results and notifying the analyzed results to a user; and a re-machining section 340 for re-machining uncut portions based on the machining error measured by the on-machine measuring and analyzing section 330.

The Internet-based STEP-NC system according to this embodiment configured as such may be constructed as an integral system, or the interface unit 400, the NPS creating unit 100, and the EPS creating unit 200 may be constructed within offline CAM software separately from the autonomous control unit 300.

FIG. 2 is a view showing an example of a STEP-NC part program in an XML format, which is inputted and outputted through the aforementioned STEP-NC part program interface 420. The STEP-NC part program expressed in the XML format is an XML expression of the NPS information on the basis of the data model defined in ISO 14649.

Referring to FIG. 2, the paragraph structure of the STEP-NC part program expressed in XML will be described below.

XML element e1 defines information on a workpiece to be machined, and its name “workpiece” is an entity name for defining a workpiece to be machined in ISO 14649. In addition, attribute “id” within the element means an instance identification (id) in XML, and “its_id”, “its_material”, “global_tolerance”, and “its_bounding_geometry” are attributes of a workpiece defined in ISO 14649. Upon analysis of the paragraph based on this rule, element e1 means that the id of the workpiece used in machining is “Complex Workpiece”, a standard tolerance of a portion where a tolerance is not particularly specified in a part shape (global tolerance) is “0.01 mm”, and “ref_{—}1” and “ref_{—}2” should be referred to for the material and bounding geometry.

Element e2 is an element defining “material” corresponding to an entity that defines a material in ISO 14649, and states “ref_{—}1” that is material id referred to by element e1. Here, “standard_identifier” and “material_identifier” define attributes of the material, and mean that the material of a corresponding workpiece is ALLOYED STEEL among materials defined in ISO 14649.

Element e3 defines “ref_{—}2” that is bounding geometry id referred to by element e1. Upon analysis of this element, the “bounding geometry” of the workpiece is a “right circular cylinder” having a height of “100 mm”, a radius of “55 mm”, and a position defined in an XML element having an id of “ref_{—}3”.

In this manner, every XML element is matched to an entity that defines the NPS in ISO 14649, and attributes of the entity corresponding to the attributes of the XML element are expressed in the same way. Therefore, a STEP-NC part program describing hardware neutral NPS information can be easily exchanged with an external system, such as a MES, PDM, and the like, through the Internet, and information on an actual machining state of a production system provided with the Internet-based STEP-NC system can be utilized in real-time in a variety of production systems and support systems.

Hereinafter, a method of creating a non-linear process plan according to an embodiment of the present invention will be described in detail.

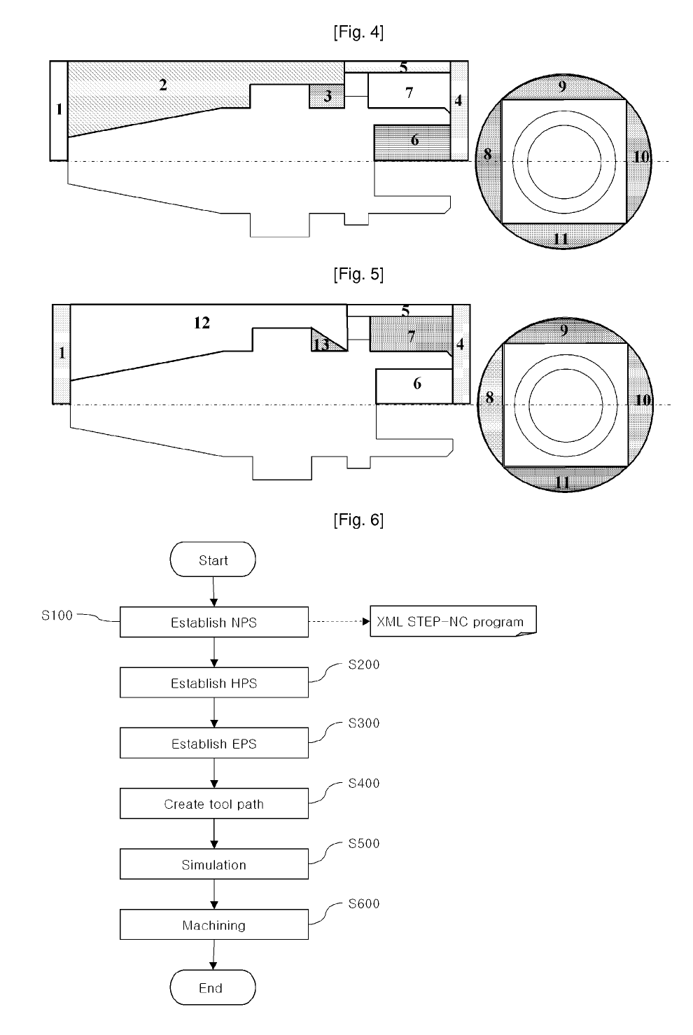

FIG. 3 is a view showing a final shape of a machined material to which a method of planning a non-linear process according to an embodiment of the present invention is applied, and FIGS. 4 and 5 are views showing examples of volume removal for machining a workpiece into the shape shown in FIG. 3.

The final shape shown in FIG. 3 is machined at a turn-mill machine tool, and can be analyzed and machined by means of a variety of volume removal methods.

For example, in FIG. 4, a removal volume for a left portion of the shape shown in FIG. 3 is divided into an outer diameter shape of number two (2) and a grooving shape of number three (3), and the removal volume is divided into an outer diameter shape of number twelve (12) and an outer diameter shape of number thirteen (13) in FIG. 5.

In addition, when executing an inner diameter workingstep for a removal volume of number six (6) shown in FIG. 4, a user may machine the corresponding shape by executing drilling first, and then selectively executing an inner diameter machining or boring process.

Accordingly, a cutting process can have a variety of machining alternatives depending on various removal volume settings and workingstep allocations as well as a single clearly defined process plan. In addition, in case of a plurality of repeated drilling processes, there may be a variety of methods of determining a machining sequence thereof.

As described above, a variety of machining methods and machining sequences can be applied to the same machined shape. Compared with a machining method employing a conventional linear process plan that is generally configured only with a sequential machining plan and one kind of predetermined machining method, a machining method of a non-linear machining plan including a variety of machining methods and machining sequences can further efficiently deal with abnormal situations that may abruptly occur.

FIG. 6 is a flowchart illustrating the method of creating a non-linear process plan using the Internet-based STEP-NC system according to the embodiment of the present invention.

First, the NPS creating unit 100 establishes an NPS, i.e., a hardware neutral non-linear process plan, using CAD data inputted through the standard CAD interface 410 (S100), and establishes an HPS, i.e., a machine dependent non-linear process plan, from the NPS information created in the NPS establishing step S100 (S200).

Next, an EPS, i.e., a non-linear process plan optimized for machining, is established from the HPS information created in the HPS establishing step S200 (S300). Then, a tool path is created from the established EPS information (S400), and it is verified whether the tool path is normal or abnormal by performing a machining simulation using the created tool path (S500).

Finally, the autonomous control unit 300 executes machining on a workpiece by controlling a machine tool based on the created EPS and tool path (S600).

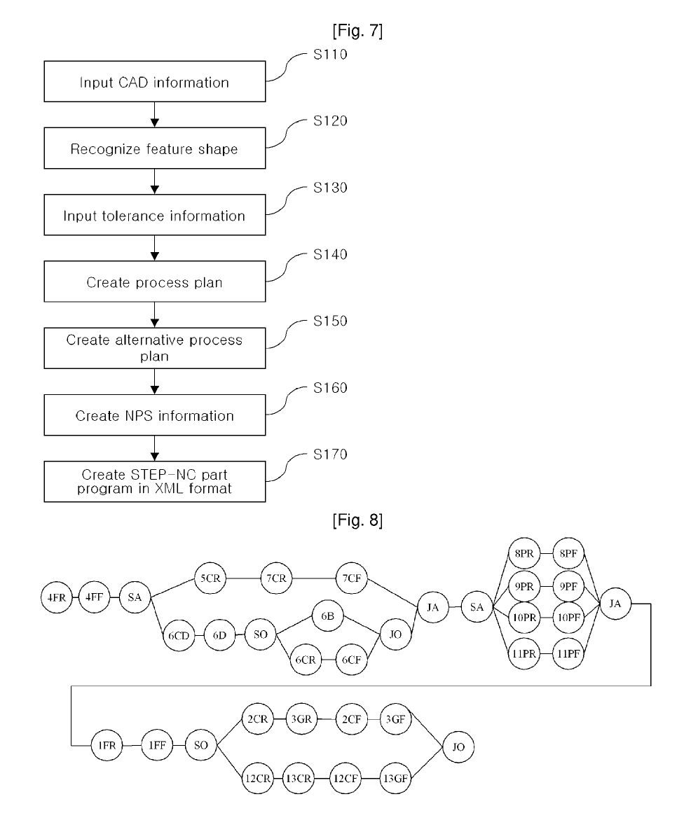

Hereinafter, the NPS establishing step S100 shown in FIG. 6 will be described in detail with reference to FIG. 7.

First, CAD information is received (S110). A removal volume of a machining material is created by analyzing the CAD information, and a feature shape corresponding to the removal volume is recognized (S120). Tolerance information for the received CAD information is inputted from the user (S130). Here, the recognized shape information is stored in the form of feature shape information conforming to milling and turning feature shape specifications defined in ISO 14649 Parts 10 and 12.

Next, a process needed for machining the workpiece material according to the recognized feature shape is planned, and detailed attribute information of each process is created (S140). Alternative processes that can substitute for a planned process are created (S150). Here, the process information is created to include a process type, machining conditions, machining strategy, tools, and the like conforming to the milling, turning, and drilling specifications defined in ISO 14649 Parts 10, 11, and 12.

Next, NPS information is created from information on the process plan and alternative process plan (S160). If there is a request from a user or an external system, a STEP-NC part program in an XML format is created using the created NPS information (S170).

FIG. 8 is a neutral process sequence graph (NPSG) diagrammatically showing the NPS information created through the procedure of FIG. 7, and is a view showing an example of the NPSG drawn using the decomposition results of the removal volume of FIGS. 4 and 5.

As shown in FIG. 8, the NPSG has arcs and nodes, in which each node contains a characteristic of the node (AND, OR, PARALLEL, MARK, or the like) or workingstep unit information (volume removal, machining conditions, tools, or the like).

The workingstep unit information is expressed by a node marked with a combination of numerals and English letters (e.g., 4FR, 4FF, 5CD, and the like), in which a numeral denotes a removal volume number shown in FIGS. 4 and 5, and an English letter denotes the type of workingstep. English letter FR for the workingstep denotes rough surface cutting, FF denotes fine surface cutting, CR denotes rough contour cutting, CF denotes fine contour cutting, CD denotes center drilling, D denotes drilling, B denotes boring, PR denotes rough plane cutting, PF denotes fine plane cutting, GR denotes rough grooving, and GF denotes fine grooving. For example, 4FR means performing rough surface cutting for a removal volume of number four (4) shown in FIG. 4.

In addition, SA, JA, SO, and JO marked on nodes denote node characteristics. Among the node characteristics, AND denotes that lower nodes can be executed regardless of a sequence and is expressed as SA (split AND) and JA (joint AND). Between the first SA and the first JA among the nodes, workingsteps 5CR, 7CR, 7CF, 6CD, 6D, 6B, 6CR, and 6CF are included. 5CR, 7CR, and 7CF on a branch split from the SA can be executed regardless of 6CD, 6D, 6B, 6CR, and 6CF on the other branch, or vice versa. Here, workingsteps connected by an arc, e.g., 5CR and 7CR, should be executed in order of the sequence of the workingsteps. Accordingly, 6CD can be performed after 5CD, and 6CD can be performed prior to 5CR.

Among the node characteristics, OR denotes that only one of lower workingsteps can be selected and executed, and is expressed as SO (split OR) and JO (joint OR). Between the first SO and the first JO among the nodes, workingsteps 6B, 6CR, and 6CF are included. 6B constructs a branch spilt from SO, and 6CR and 6CF construct another branch. At this time, OR means that either of the branch of 6B or the branch of 6CR and 6CF is selected and executed.

In this manner, the NPSG can express workingsteps that can be executed regardless of an execution sequence, and alternative workingsteps that can be selectively executed, by using AND and OR.

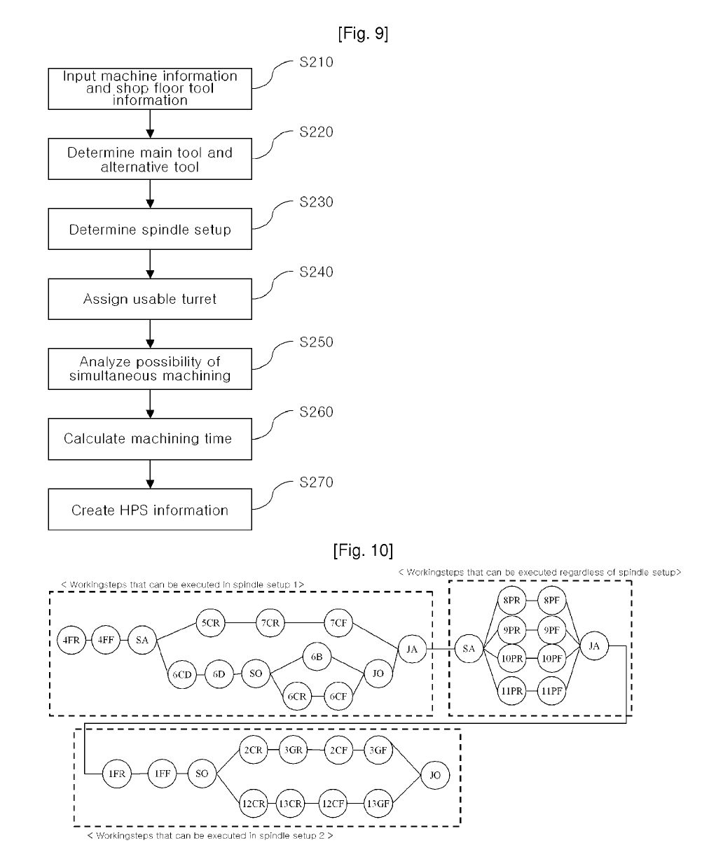

Hereinafter, the HPS establishing step S200 shown in FIG. 6 will be described in detail with reference to FIG. 9.

First, machine tool specification information and field tool information are received through the machine tool configuration information interface 430 and the tool information interface 440 (S210). Here, the machine tool information includes information defining axes of a machine tool and the structures and performances of a turret and a spindle of the machine tool, additional information such as use of cutting oil or the like, information on measurement equipment such as a touch probe attached to the machine tool, and information on clamping equipment such as a tail stock attached to the machine tool.

Next, for each workingstep of the NPS created in the NPS establishing step S100, a main tool, which will be used until the tool is unusable due to breakage or wear, and an alternative tool, which will substitute for the main tool when the main tool is broken, are determined from the received tool information (S220). In order to select the main tool, the shape of a removal volume to be removed through the workingstep and the type of the process should be considered, together with the rigidity, life span and machining conditions of the tool needed for the workingstep. A tool that can perform the same process for the same removal volume to be removed by the main tool is determined as an alternative tool.

Next, a setup of a spindle that will be used for each workingstep of the NPS created in the NPS establishing step S100 is determined (S230). The spindle setup should be determined to be used depending on the form, mechanical characteristics, quality and the like of a final shape.

A workpiece is fixed to a lathe or a multi-tasking machine by a chuck, and the workpiece is deformed or the quality of a machined surface is lowered due to a gripping force of the chuck. Therefore, a spindle setup sequence is determined so that a portion where high quality is required or a thin film shape that is easily bent cannot be gripped by the chuck. In addition, a slanted shape or the like that is not easily gripped by the chuck should be machined after any other portions are machined. This should be considered in determining the spindle setup sequence. Generally, since a spindle setup is assigned to each spindle in a multi-tasking machine having two spindles, each workingstep that should be performed by the two spindles is made through two spindle setups. (Hereinafter, a spindle setup that is executed first in an execution sequence is defined as spindle setup 1, and a spindle setup that is executed later is defined as spindle setup 2.)

Through the spindle setup determining step S230, workingsteps can be categorized into workingsteps that can be executed only for a specific spindle setup and workingsteps that can be executed regardless of a spindle setup.

Next, a turret to be used for each workingstep of the NPS that has been created in the NPS establishing step S100 is assigned (S240). The turret is a component that implements motions of axes in a multi-tasking machine, and a usable axis and a machining area are determined depending on the performance of the turret. A usable turret that can be used is determined by comparing the movable axis and the machining area in the turret with the type of workingstep to be executed and the location of a removal volume.

Then, it is determined whether simultaneous machining (one-feature simultaneous machining or two-feature simultaneous machining) that is to be applied upon execution of combined machining for each workingstep can be executed (S250).

The one-feature simultaneous machining (balanced machining) is a machining method that can enhance the quality of machining, and it is desirable to determine the one-feature simultaneous machining to be executed for an outer shape (including grooving) in a lathe. The two-feature simultaneous machining is a machining method in which two turrets execute machining for two different portions of the same part, and the same spindle speed should be applied to workingsteps that are executed by the two-feature simultaneous machining. Accordingly, in order to determine whether to execute the two-feature simultaneous machining, if spindle speeds in the two workingsteps are adjusted to be the same, it is examined whether the workingsteps can be executed within the available cutting speed of a main tool assigned to each of the workingsteps, thereby determining whether to execute the two-feature simultaneous machining.

Next, a tool path is created in consideration of machining strategy, machining conditions, and removal volumes defined in each workingstep, and a machining time is calculated for each workingstep using the created tool path (S260).

Finally, HPS information for all workingsteps is created using the information created in steps S220 to S260 (S270). The HPS information is workingstep information where machining workingstep information defined in ISO 14649 Part 10 is supplemented with information on field tools to be used when executing the workingsteps, information on alternative tools for substituting for a broken tool, information on turrets and spindles available when executing the workingsteps, information on whether one-feature simultaneous machining is available, information on machining conditions of one-feature simultaneous machining, information on whether two-feature simultaneous machining is available, information on machining conditions of two-feature simultaneous machining, a machining time required for general machining, a machining time required for one-feature simultaneous machining, and a machining time required for two-feature simultaneous machining.

FIG. 10 is a hardware-dependent process sequence graph (HPSG) graphically showing the HPS information created in the steps of FIG. 9 and is a view showing an example of the HPSG drawn from the NPS shown in FIG. 8 when machining is executed by a multi-tasking machine having two spindles.

The HPSG is configured with the same workingsteps as those of the NPSG and is applied with the same workingstep sequence as that of the NPSG. However, workingstep information included in a node is configured differently from that of the NPSG.

As shown in FIG. 10, workingsteps 4FR, 4FF, 5CR, 7CR, 7CF, 6CD, 6D, 6B, 6CR, and 6CF can be executed when an executable spindle setup is spindle setup 1, i.e., executed only at the left side spindle, and workingsteps 1FR, 1FF, 2CR, 3GR, 2CF, 3GF, 12CR, 13CR, 12CF, and 13GF can be executed when an executable spindle setup is spindle setup 2, i.e., executed only at the right side spindle. On the other hand, workingsteps 8PR, 8PF, 9PR, 9PF, 10PR, 10PF, 11PR, and 11PF can be executed at any spindle regardless of a spindle setup.

On the other hand, the EPS can be established from the HPS information created in the HPS establishing step S200 by determining a spindle setup to be applied to workingsteps that can be executed regardless of a spindle setup, determining workingsteps to be executed among alternative workingsteps, determining an execution sequence of random workingsteps, and determining whether to apply simultaneous machining to workingsteps to which the simultaneous machining can be applied.

Before specifically describing the EPS establishing step, a performance index used as a criterion for creating EPS information will be described first.

A variety of performance indexes can be used to determine the EPS from the HPS. In this embodiment, a performance index that can minimize a machining time is selected. The machining time can be more specifically defined as a cycle time. The cycle time means a time span needed to machine a workpiece by a machine tool, and one cycle means workingsteps that are executed to machine a workpiece by a machine tool.

For example, a cycle time of a machine tool that can execute only one workingstep at a time, such as a lathe or a milling machine, is calculated as the sum of a loading time, a machining time, a setup exchanging time and an unloading time. In addition, parallel machining for simultaneously machining two workpieces is allowed in a multi-tasking machine having two turrets and two spindles, in which a cycle time should be calculated in a method different from that of general machining.

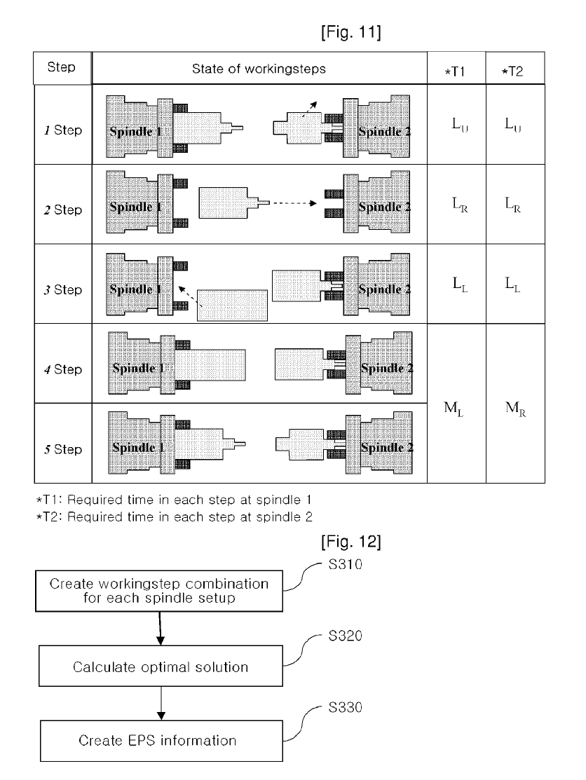

FIG. 11 is a view showing the steps of executing one cycle, i.e., the steps of machining a workpiece, when executing parallel machining by a multi-tasking machine having two turrets and two spindles.

The multi-tasking machine first executes machining at a left side spindle and then moves a workpiece to a right side spindle to execute the remaining machining process. Accordingly, the workpiece is loaded at the left side spindle and unloaded from the right side spindle.

As shown in FIG. 11, one cycle comprises a first step of unloading a workpiece mounted on the right side spindle, a second step of moving a workpiece mounted on the left side spindle to the right side spindle, a third step of loading a new workpiece on the left side spindle, a fourth step of starting to execute machining for the workpieces mounted on both spindles, and a fifth step of completing the machining.

Accordingly, a cycle time of the multi-tasking machine having two turrets and two spindles can be obtained as shown in the following formula 1.

Max[(LL+LR+LU+ML),(LL+LR+LU+MR)] (1)

(LL denotes a time span for loading a workpiece on the left side spindle, LR denotes a time span for moving a workpiece from the left side spindle to the right side spindle, LU denotes a time span for unloading a workpiece from the right side spindle, ML denotes a time span for machining a workpiece at the left side spindle, and MR denotes a time span for machining a workpiece at the right side spindle.)

Since the loading time, unloading time and moving time of formula 1 are constant, the cycle time is proportional to the maximum value of ML and MR, and a performance index related to the machining time can be defined as the following formula 2.

Max[ML,MR] (2)

In this manner, an EPS that can minimize the performance index of formula 2 is created.

Hereinafter, the EPS establishing step S300 shown in FIG. 6 will be described with reference to FIG. 12.

First, all combinations of workingsteps that can be assigned to each spindle setup are created. The workingstep combinations are created by assigning workingsteps that can be executed regardless of a spindle setup to a specific spindle setup and selecting workingsteps to be executed among alternative workingsteps, thereby creating a list of all possible workingstep combinations (S310). ETAWS (Evaluation Table for Assigning Workingstep to each Setup) in which all workingstep combinations are arranged is preferably used to estimate a cycle time for each workingstep combination.

In the ETAWS, workingsteps that can be executed regardless of a spindle setup greatly changes the cycle time depending on a spindle setup in which the workingsteps are executed. Accordingly, all number of cases where workingsteps unrelated to a spindle setup can be assigned to each spindle setup is found out, and a cycle time for each case is estimated.

In addition, since alternative workingsteps expressed as OR in the HPSG also can greatly change the cycle time depending on selected workingsteps, all cases where the workingsteps are selected are found out to estimate a cycle time.

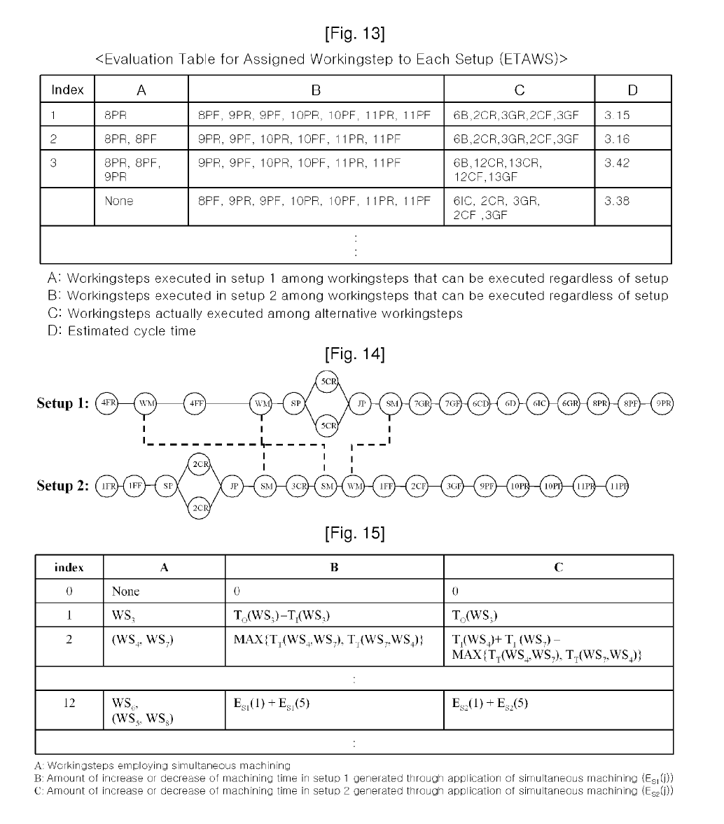

FIG. 13 is a view showing an ETAWS created from the HPSG shown in FIG. 10.

In FIG. 13, column A shows workingsteps executed in spindle setup 1 among workingsteps that can be executed regardless of a spindle setup, column B shows workingsteps executed in spindle setup 2, column C shows execution workingsteps among alternative workingsteps, and column D shows estimated cycle times of corresponding rows.

In the HPSG shown in FIG. 10, workingsteps that can be executed regardless of a spindle setup are 8PR, 8PF, 9PR, 9PF, 10PR, 10PF, 11PR, and 11PF, and alternative workingsteps are 6B, 6CR, 6CF, 2CR, 3GR, 2CF, 3GF, 12CR, 13CR, 12CF, and 13GF. The first row of the ETAWS shows workingstep 8PR executed in spindle setup 1, workingsteps 8PF, 9PR, 9PF, 10PR, 10PF, 11PR, and 11PF executed in spindle setup 2, workingsteps 6B, 2CR, 3GR, 2CF, and 3GF selected as execution workingsteps from alternative workingsteps. The estimated cycle time thereof is 3.15 minutes. A row in the ETAWS corresponds to one case where a spindle setup is assigned and execution workingsteps are selected, and as many rows as all possible cases are created. The rows created as such are arranged in ascending order of the estimated cycle time. As the estimated cycle time is smaller, it is considered that a possibility of obtaining an optimal solution is higher.

Here, a method of estimating a cycle time for a workingstep schedule of an intermediate step will be described in detail below.

When workingstep combinations are created in the workingstep combination creating step S310, an execution sequence of random execution workingsteps in each spindle setup is determined from the created workingstep combinations, it is determined whether to apply simultaneous machining to workingsteps capable of simultaneous machining, and an optimal solution is calculated by evaluating the performance index of formula 2 (S320). A method of calculating an optimal solution will be described later.

Finally, EPS information is created from the optimal solution calculated in step S320. The created EPS information is information in which attribute information, such as information on turrets and spindles used when actually executing workingsteps, whether to execute simultaneous machining, workingsteps to be executed together upon execution of two-feature simultaneous workingsteps, tools to be used upon execution of workingsteps, tool paths, machining time, and workingstep starting time on the whole schedule, is added to the HPS information created in step S200.

FIG. 14 is an executive process sequence graph (EPSG) diagrammatically showing the EPS information created in the procedure of FIG. 12, and is a view showing an example of the EPSG drawn from the HPS shown in FIG. 10.

As shown in FIG. 14, the EPSG is used for real-time execution, in which all random executions, alternative executions and the like expressed as AND (SA-JA), OR (SO-JO), or the like in the NPSG and the HPSG are removed. In addition, contrary to the NPSG and the HPSG, the EPSG does not use nodes having attributes of AND and OR, but uses nodes having attributes of PARALLEL and MARK.

A PARALLEL node is expressed as split parallel (SP) or joint parallel (JP) and means that workingsteps on branches split from the SP are executed simultaneously, and also means, in a multi-tasking machine having a plurality of turrets, that two or more turrets simultaneously start to work. For example, the PARALLEL node defined in spindle setup 1 of FIG. 14 shows that workingstep 5CR is one-feature simultaneous machining that is simultaneously executed by two turrets.

A MARK node defines whether synchronization is made between turrets in a machine tool having a plurality of turrets or channels. A MARK node is expressed as a set mark (SM) or a wait mark (WM), and the WM functions to temporarily suspend execution of workingsteps in the spindle setup to which the WM belongs until an SM is executed in a counterpart setup. For example, the second node of spindle setup 1 of FIG. 14 is a WM which means that execution of workingsteps in spindle setup 2 is temporarily suspended until workingsteps 1FR and 2CR are completed in spindle setup 2, after workingstep 4FR is executed.

In the EPSG, a WM and an SM associated with each other are connected by a dotted line. Upon execution of the SM, the WM connected thereto by a dotted line releases a waiting state and executes subsequent workingsteps. Through the use of the WM and SM, the EPSG can implement synchronization between setups for simultaneous machining or the like.

Hereinafter, a method of estimating a cycle time for an intermediate schedule through a cycle time effect map (CTEM) will be described.

Simultaneous machining in a multi-tasking machine can reduce a machining time compared with general machining (machining that is executed independently from other workingsteps by using one turret and one spindle). One-feature simultaneous machining reduces the machining time of a workingstep to which simultaneous machining is applied, and two-feature simultaneous machining reduces the machining span time in a setup including a workingstep to which simultaneous machining is applied, rather than reducing the machining time of a workingstep to which simultaneous machining is applied. However, since the simultaneous machining uses a turret, which is used to execute a workingstep included in a counterpart setup, for the simultaneous machining and thus hinders execution of a workingstep in the counterpart setup, the machining span time in the counterpart setup increases. Therefore, when simultaneous machining is applied, the amount of increase or decrease of the machining time in each spindle setup needs to be taken into consideration. Here, the amount of increase or decrease of the machining time in each setup due to the simultaneous machining as compared with basic machining is defined as a “simultaneous machining effect”.

The CTEM shows the simultaneous machining effect having influence on each setup when simultaneous machining is applied to some of workingsteps capable of simultaneous machining and general machining is applied to the other workingsteps. A row configuring the CTEM is a case where simultaneous machining is applied.

FIG. 15 is a view showing an example of a CTEM, in which workingsteps capable of one-feature simultaneous machining are WS3, WS5 and WS6, and pairs of workingsteps capable of two-feature simultaneous machining are (WS4, WS7) and (WS5, WS8). Among them, workingsteps WS3, WS5, WS6 and WS8 are executed in setup 1, and workingsteps WS4 and WS7 are executed in setup 2.

The first row of the CTEM of FIG. 15 shows simultaneous machining effects of setup 1 and setup 2 in a case where only workingstep WS3 is executed by a simultaneous machining method and the other workingsteps capable of simultaneous machining are executed by a general machining method. In addition, the twelfth row shows simultaneous machining effects of setup 1 and setup 2 in a case where workingsteps WS3 and WS6 are executed by a one-feature simultaneous machining method and workingstep pairs of (WS4, WS7) and (WS5, WS8) are executed by a two-feature simultaneous machining method.

The following formula 3 is a formula for calculating the amount of decrease of the machining time in a setup that executes simultaneous machining in a case where one-feature simultaneous machining is applied, and the following formula 4 is a formula for calculating the amount of increased of the machining time in a setup that does not execute simultaneous machining.

Eₛ₁(j)=T₀(WSᵢ)−T_{I}(WSᵢ) (3)

Eₛ₂(j)=T₀(WSᵢ) (4)

(Eₛ₂(j) is a simultaneous machining effect in spindle setup 1 of the j-th row of the CTEM, Eₛ₂(j) is a simultaneous machining effect in spindle setup 2 of the j-th row of the CTEM, T_{O} (WSᵢ) is a machining time when workingstep WSᵢ is executed by a one-feature simultaneous machining method, and T_{I} (WSᵢ) is a machining time when workingstep WSᵢ is executed by a general simultaneous machining method.)

The following formula 5 is a formula for calculating the amount of decrease of the machining time in a setup that executes simultaneous machining in a case where two-feature simultaneous machining is applied, and the following formula 6 is a formula for calculating the amount of increase of the machining time in a setup that does not execute simultaneous machining.

Eₛ₁(j)=T_{I}(WSᵢ)+T_{I}(WSⱼ)−MAX(T_{T}(WSᵢ,WSⱼ),T_{T}(WSⱼ,WSᵢ)) (5)

(T_{T}(WSᵢ,WSⱼ) is a machining time of workingstep WSᵢ when workingstep WSᵢ and WSⱼ are executed by a two-feature simultaneous machining method, and T_{T} (WSⱼ, WSᵢ) is a machining time of workingstep WSⱼ when workingstep WSᵢ and WSⱼ are executed by a two-feature simultaneous machining method.)

Es₂(j)=MAX(T_{T}(WSᵢ,WSⱼ) (6)

Using the CTEM created as such and the following formula 7, a cycle time that most efficiently employs simultaneous machining can be estimated.

CT_{E}=MIN{MAX(ET_{S1}(j),ET_{S2}(j))} for ∀j (7)

(CT_{E} is a cycle time, ET_{S1}(j) is a machining time of setup 1 when simultaneous machining of the j-th row of the CTEM is applied, and ET_{S2}(j) is a machining time of setup 2 when simultaneous machining of the j-th row of the CTEM is applied.)

ET_{S1}(j) and ET_{S2}(j) of formula 7 can be obtained from the following formulas 8 to 10.

ETs₁(j)=DT_{S1}+T_{L}(R_{S1})+E_{S1}(j) (8)

ETₛ₂(j)=DT_{S2}+T_{L}(R_{S2})+E_{S2}(j) (9)

$${T}_{L} ( R ) = {\sum }_{{WS}_{i} ∈ R} {T}_{I} ( {WS}_{i} ) \qquad ( 10 )$$

(DT_{S1} is a machining time of workingsteps of which schedules are determined in spindle setup 1, DT_{S2} is a machining time of workingsteps of which schedules are determined in spindle setup 2, E_{S1}(j) is a simultaneous machining effect for spindle setup 1 of the j-th row of the CTEM, E_{S2}(j) is a simultaneous machining effect for spindle setup 2 of the j-th row of the CTEM, R is a set of workingsteps to be sequentially executed in a specific spindle setup, and T_{L}(R) is a machining time when workingsteps in the set are sequentially executed.)

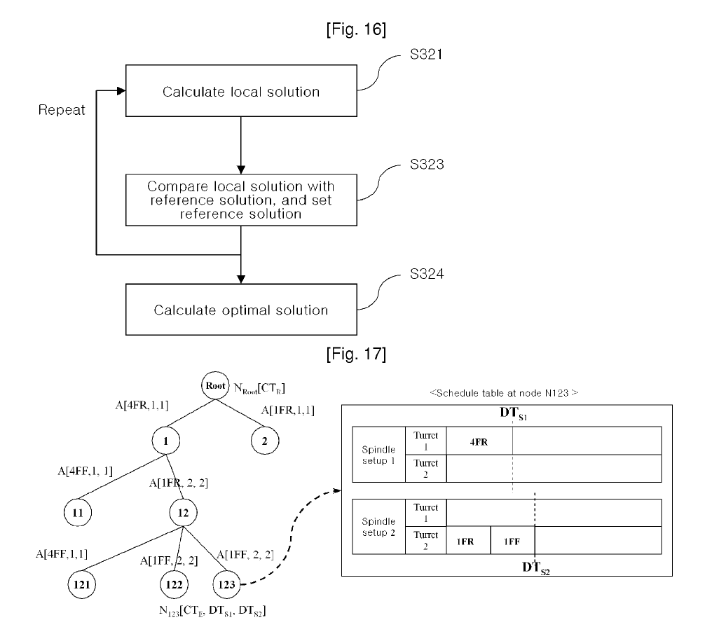

Hereinafter, a method of calculating an optimal solution in the optimal solution calculating step S320 will be described with reference to FIG. 16.

First, a branch-and-bound algorithm is applied to a specific workingstep combination among the workingstep combinations created in the workingstep combination creating step S310 and contained in the ETAWS, thereby obtaining a local solution in which a machining schedule is set for the corresponding workingstep combination (S321).

Next, cycle times of the local solution and a reference solution are compared. If the cycle time of the local solution is smaller, the reference solution substitutes for the local solution (S323). However, since the initially calculated local solution does not have a previously existing reference solution, the corresponding local solution is set to the reference solution.

The above steps are repeated for all workingstep combinations contained in the ETAWS, and a finally obtained reference solution is determined as the optimal solution (S324). Here, the above steps are repeated in ascending order of the estimated cycle time of a workingstep combination in the ETAWS. However, workingstep combinations having an estimated cycle time larger than the cycle time of the reference solution are preferably excluded from targets of local solution calculation to reduce an optimal solution calculation time.

FIG. 17 is a view showing an example of a solution search tree for obtaining a local solution by applying the branch-and-bound algorithm in step S321 described above.

A root node marked as Root in FIG. 17 is a node representing an empty schedule with an attribute expressed as N_{Root}[CT_{R}], where CT_{R} denotes a reference cycle time corresponding to the cycle time of the reference solution obtained in step S323.

A solution tree is constructed from the root node such that starting from the root node, i.e., starting from an empty schedule, a workingstep that can be added to the empty schedule is selected and placed onto the schedule through a branching process, thereby searching for an intermediate solution.

At this time, the intermediate solution is represented as a child node of the root node, and each node has independent schedule information. An evaluation process of estimating a cycle time is performed on the child node created as such, and the evaluation result is compared with the reference cycle time to prune a node having an evaluation result larger than the reference cycle time. As described above, the reference cycle time is a value used as a reference for pruning, which functions as an important variable for efficiently executing the branch-and-bound algorithm.

Next, a node having the smallest estimated cycle time is selected among remaining nodes that are not pruned, and branching, evaluating, and pruning processes are continuously repeated to find a final solution.

The child node created through branching corresponds to an intermediate schedule marked with a numeral, such as 1, 2, 11, 12, or the like shown in FIG. 17, and has an attribute expressed in the same manner as N₁₂₃[CT_{E}, DT_{S1}, DT_{S2}] of node 123. Here, CT_{E} denotes an estimated cycle time, and DT_{S1} and DT_{S2} respectively denote ending times of all scheduled workingsteps in spindle setup 1 and setup 2 on the schedule contained in the node. In addition, arcs configuring the tree are expressed as A[WSᵢ, Sⱼ, Tₖ] which means that workingstep WSᵢ is executed in setup j using turret k. That is, a schedule of node 123 is created by placing workingstep 4FR at spindle setup 1 and turret 1, workingstep 1FR at spindle setup 2 and turret 2, and workingstep 1FF at spindle setup 2 and turret 2, which can be represented as a schedule table shown in FIG. 17.

Hereinafter, the aforementioned branching method will be described below in greater detail.

Branching is a process of selecting one of workingsteps that can be added to the schedule contained in a specific node and assigning the selected workingstep to an appropriate location of the schedule (a specific setup and turret), in which a workingstep having high machining priority is selected and assigned among the nodes (workingsteps) connected through arcs in the HPSG. At this time, the number of created child nodes is the same as the number of workingsteps that can be added to the schedule contained in the parent node.

However, all possible child nodes are not necessarily branched from the parent node, and a predetermined branching rule is preferably applied to efficiently branch a child node. The branching rule includes a rule for minimizing difference in machining time between spindle setups of which schedules are determined in the process of searching for a solution through the branching-and-bound algorithm (branching rule 1) and a rule for preventing repetitively searching for the same schedule while creating the EPSG (branching rule 2), and each of the rules can be represented as described below.

(Branching Rule 1)

If DT_{S1} is smaller than DT_{S2}, a workingstep that can be executed in spindle setup 1 is branched as a child node. If DT_{S1}(K) is larger than DT_{S2}(K), a workingstep that can be executed in spindle setup 2 is branched as a child node. However, workingsteps that should be executed through simultaneous machining are branched regardless of a spindle setup.

(Branching Rule 2)

If DT_{S1} is equal to DT_{S2}, only the workingsteps that can be executed in a certain spindle setup are selected among workingsteps that can be child nodes, and branching is performed on these workingsteps. At this time, workingsteps executed through simultaneous machining are branched regardless of a spindle setup.

For simultaneous machining in a multi-tasking machine, synchronization is needed to suspend execution of a spindle setup and to simultaneously execute the same workingstep (one-feature simultaneous machining) or different workingsteps (two-feature simultaneous machining) by two turrets, and thus, an idle time inevitably occurs at one turret due to the synchronization. Since the idle time increases the cycle time, it should be minimized to enhance the efficiency of the EPSG. Accordingly, the branching rule is applied to minimize the difference in machining time between two spindle setups in order to minimize the idle time even though simultaneous machining is immediately executed in an intermediate step of creating the EPSG.

Branching rule 2 is applied when branching rule 1 is not applied, i.e., when DT_{S1} is equal to DT_{S2}. In this case, if the branch-and-bound algorithm is applied, a problem of inefficiency of repetitively searching for the same solution occurs. This problem can be avoided by applying branching rule 2.

The present invention described above is not limited to the aforementioned embodiments and the accompanying drawings. It will be readily apparent to those skilled in the art that various substitutions, modifications and changes can be made thereto without departing from the technical spirit and scope of the present invention.

### INDUSTRIAL APPLICABILITY

In the method of creating a non-linear process plan according to the present invention, a STEP-NC machine tool can autonomously execute machining optimized depending on field situations and can autonomously deal with abnormal situations that may occur during machining, thereby enabling construction of an unmanned machining system with enhanced productivity.

In addition, since STEP-NC part programs in an XML format can be freely exchanged through the Internet between machine tools provided with the Internet-based STEP-NC system according to the present invention, global manufacturing independent of the type of machine tool can be achieved.

1. An Internet-based STEP-NC system for controlling a STEP-NC machine tool by using a non-linear process plan, the system comprising:
an interface unit for receiving CAD information, machine information and tool information, and for processing input and output of a STEP-NC part program in an XML format;
an NPS (Neutral Process Sequence) creating unit for creating NPS information from CAD data transmitted from the interface unit;
an EPS (Executive Process Sequence) creating unit for creating HPS (Hardware-dependent Process Sequence) information, EPS information, and tool paths from machine tool configuration information and tool information transmitted from the interface unit and the NPS information created by the NPS creating unit; and
an autonomous control unit for controlling the machine tool, machining a workpiece, and dealing with abnormal situations based on the EPS information transmitted from the EPS creating unit.

2. The system as claimed in claim 1, wherein the interface unit comprises:
a standard CAD interface for receiving and analyzing the CAD information;
a STEP-NC part program interface for receiving the STEP-NC part program in the XML format and converting the received STEP-NC part program into internal machining information, or converting internal machining information into a STEP-NC part program and outputting the converted STEP-NC part program;
a machine tool configuration information interface for receiving and analyzing the machine tool configuration information;
a tool information interface for receiving and analyzing the tool information; and
a G-code interface for converting tool path information into G-codes and outputting the converted G-codes.

3. The system as claimed in claim 2, wherein the STEP-NC part program interface matches an entity defining the NPS in ISO 14649 and an XML element to each other, and represents attributes of the entity as attributes of the XML element, so that the STEP-NC part program in the XML format in which the NPS information is described is exchanged with external systems.

4. A method of non-linear process planning for a STEP-NC system, the method comprising the steps of:
establishing an NPS (hardware neutral non-linear process plan) using inputted CAD data;
establishing an HPS (hardware-dependent non-linear process plan) from information on the NPS created in the step of establishing the NPS;
establishing an EPS from information on the HPS created in the step of establishing the HPS; and
creating a tool path from information on the EPS created in the step of establishing the EPS.

5. The method as claimed in claim 4, wherein the step of establishing the NPS comprises the steps of:
receiving the CAD data;
analyzing the CAD data to create a removal volume of a material to be machined and recognizing a feature shape corresponding to the removal volume;
receiving tolerance information for the inputted CAD data from a user;
planning processes needed for machining the workpiece according to the recognized feature shape and creating detailed attribute information of each process;
creating alternative processes for substituting for the planned processes; and
creating NPS information from information on the process plan and the alternative process plan.

6. The method as claimed in claim 4, wherein the step of establishing the HPS comprises the steps of:
receiving machine tool specification information and field tool information;
determining, from the received tool information, a main tool preferentially used for each of workingsteps that configure the NPS information created in the step of establishing the NPS, and an alternative tool that can substitute for the main tool if the main tool is broken;
determining a setup of a spindle used for each of the workingsteps;
assigning a turret used for each of the workingsteps;
determining whether it is possible to execute simultaneous machining that is to be applied upon execution of combined machining for each of the workingsteps;
calculating a machining time of each workingstep from the tool path created in each of the workingsteps; and
creating HPS information for all workingsteps using information on the main tool, the alternative tool, the spindle setup, the turret, the possibility of executing simultaneous machining, and the machining time determined for each of the workingsteps.

7. The method as claimed in claim 4, wherein the step of establishing the EPS comprises the steps of:
creating workingstep combinations for assigning execution workingsteps to each spindle setup using the HPS information and spindle information of a machine tool;
determining a workingstep execution sequence in each spindle setup from the workingstep combinations created in the step of creating the workingstep combinations, determining whether to apply simultaneous machining to workingsteps capable of simultaneous machining, and calculating an optimal solution that can minimize a cycle time; and
creating the EPS information for the STEP-NC system using the calculated optimal solution.

8. The method as claimed in claim 7, wherein the step of calculating the optimal solution comprises the steps of:
calculating a local solution by setting a machining schedule considering simultaneous machining for a specific workingstep combination among the workingstep combinations created in the step of creating the workingstep combinations;
if the local solution is an initial local solution or the local solution has a cycle time smaller than that of a reference solution, setting the local solution to the reference solution; and
obtaining the optimal solution from a final reference solution.

9. The method as claimed in claim 8, wherein the step of creating the workingstep combinations comprises precalculating an estimated cycle time for each of the created workingstep combinations, and
the step of calculating the local solution comprises calculating a corresponding local solution in ascending order of the estimated cycle time among the workingstep combinations created in the step of creating the workingstep combinations while excluding workingstep combinations having an estimated cycle time larger than the cycle time of the reference solution from targets of the local solution calculation.

10. The method as claimed in claim 8, wherein the step of creating the local solution comprises the steps of:
selecting a workingstep that can be added to a workingstep of a specific node and branching the selected workingstep as a child node by placing the selected workingstep onto a schedule while starting from a root node that is initially an empty node;
performing an evaluation process of estimating a cycle time of the created child node;
pruning a node having a cycle time larger than the cycle time of the reference solution by comparing a result of the evaluation with the cycle time of the reference solution; and
obtaining the final solution by selecting a node having a smallest estimated cycle time among remaining nodes that are not pruned, and repeating the branching, evaluating, and pruning steps.

11. The method as claimed in claim 10, wherein the step of branching comprises the steps of:
comparing machining times of workingsteps scheduled in each spindle setup at a branching target node, and branching a workingstep that can be executed in a spindle setup having a smaller machining time as a child node, and
if the compared machining times are equal to each other, branching a workingstep that can be executed in a certain spindle setup as a child node.
